(19) United States
(12) Patent Application Publication
(10) Pub. No.: US 2025/0011211 A1
(43) Pub. Date: Jan. 9, 2025

(54) APPARATUS AND METHOD FOR RECOVERING MINERALS USING NANOFILTRATION MEMBRANE

(71) Applicants: Carmelo MORGANTE, Grotte (IT); Vittorio BOFFA, Aalborg (DK); Julio López RODRÍGUEZ, Barcelona (ES); Jose Luis Cortina PALLAS, Molins de Rei (ES); ACWA POWER Company, Riyadh (SA)

(72) Inventors: Carmelo MORGANTE, Grotte (IT); Vittorio BOFFA, Aalborg (DK); Julio López RODRÍGUEZ, Barcelona (ES); Jose Luis Cortina PALLAS, Molins de Rei (ES); Ratul DAS, Thuwal (SA); Thomas ALTMANN, Dubai (AE)

(21) Appl. No.: 18/757,317

(22) Filed: Jun. 27, 2024

Related U.S. Application Data
(60) Provisional application No. 63/512,020, filed on Jul. 5, 2023.

(51) Int. Cl. C02F 9/00; B01D 61/12; B01D 67/00; B01D 69/02; B01D 71/02; B01D 71/68; C02F 1/44; C02F 101/20; C02F 103/08

(52) U.S. Cl. CPC C02F 9/00; B01D 61/12; B01D 67/0088; B01D 69/02; B01D 71/028; B01D 71/68; B01D 2325/16; C02F 1/441; C02F 1/442; C02F 1/444; C02F 2101/206; C02F 2103/08

(57) ABSTRACT

An apparatus and a method for recovering minerals uses a metal-organic-framework (MOF)-based Nanofiltration (NF) membrane, and there is also a method for fabricating an NF membrane. The fabricating method includes preparing a first layer as a coating solution that includes chitosan, an acid solution, metal oxide nanoparticles, and an MOF. A second step involves both pre-treating a second layer by immersing it into a base solution to activate a substrate surface of the second layer, and fabricating the NF membrane by coating the second layer with the coating solution to form the first layer on the second layer. The first layer has a positive-surface charge selectively to repel one or more minerals from a liquid stream for recovery.

### CROSS-REFERENCE TO RELATED APPLICATIONS

This application claims priority to U.S. Provisional Patent Application Ser. No. 63/512,020, filed Jul. 5, 2023, and entitled “METAL-ORGANIC-FRAMEWORK-BASED NANOFILTRATION MEMBRANE FOR SELECTIVE RECOVERY”, the disclosure of which is incorporated herein by reference.

### TECHNOLOGICAL FIELD

This disclosure generally relates to seawater reverse osmosis (SWRO) process, and more particularly relates to apparatus and methods for extracting minerals from seawater using metal organic framework-based nanofiltration (NF) membrane.

### BACKGROUND

To meet the increasing global demand for freshwater, SWRO has become a widely used process to produce freshwater from seawater. As a result, the volume of brine containing concentrated salts, minerals and chemical residues that needs to be discharged to the environment has increased. Brine contains a concentrated amount of ions, such as sodium, magnesium, calcium, chlorides, sulphates, and carbonates that may have economic importance and may be used in everyday life. As a result, current research has shifted the perception of the brine of desalination plants from being waste to a high-value resource for minerals recovery.

Due to higher concentration of minerals present in brines compared to seawater, the concentrated brine may be utilized for mineral recovery. Conventionally for the recovery of such minerals, solutions adopting a Zero Liquid Discharge (ZLD) and/or Minimum Liquid Discharge (MLD) approach have been proposed. However, the minerals recovered from this solution do not meet the required specifications making it economically unfeasible.

Therefore, there is a need for optimized solutions for improving purity of recovered minerals to make the mineral recovery process economically viable.

### BRIEF SUMMARY

The present invention discloses an apparatus and a method for recovering specific minerals from the seawater by utilizing a nanofiltration membrane, thereby making extraction of such minerals economically feasible.

In one aspect, a method for fabricating a Nanofiltration (NF) membrane is provided. The method may include preparing a first layer as a coating solution. The coating solution may include a chitosan, an acid solution, one or more metal oxide nanoparticles, and a Metal-Organic Framework (MOF). The method may further include pre-treating a second layer by immersing the second layer into a base solution. This may activate a substrate surface of the second layer. The method may further include fabricating the NF membrane by coating the second layer with the coating solution, such that the coating solution forms the first layer on the second layer. The first layer includes a positive surface charge to repel one or more minerals from a liquid stream for recovery thereof.

In an embodiment, the MOF may include an amino-functionalized Material Institute Lavoisier (MIL)-101.

In an embodiment, the second layer is made of a polysulfone ultrafiltration (UF) substrate.

In an embodiment, the one or more minerals recovered using the NF membrane may include at least one of magnesium (Mg²⁺), and calcium (Ca²⁺).

In another aspect, an apparatus for recovering minerals using an NF membrane is provided. The apparatus may include one or more processors configured to control an inlet to receive a liquid stream including a first set of minerals. The one or more processors may be further configured to control a recovery unit to recover one or more minerals from the first set of minerals by passing the liquid stream through the NF membrane having a positive surface charge that repels the one or more minerals for recovery. The liquid stream passes through the NF membrane to output at least an NF permeate stream and an NF retentate stream. The NF retentate stream includes the one or more minerals. The one or more processors may be further configured to control an outlet to output the NF retentate stream including the one or more minerals to recover the one or more minerals.

In an embodiment, the NF membrane may include a first layer having a positive surface charge that selectively repels the one or more minerals for the recovery, and a second layer to provide mechanical support to the first layer.

In an embodiment, the first layer is made of a Metal Organic Framework (MOF), metal oxide nanoparticles and a chitosan matrix.

In an embodiment, the MOF may include an amino-functionalized Material Institute Lavoisier (MIL)-101.

In an embodiment, the second layer is made of a polysulfone ultrafiltration (UF) substrate.

In an embodiment, the first set of minerals may include at least one of magnesium (Mg²⁺), calcium (Ca²⁺), sodium (Na⁺), chloride (Cl⁻), and sulphates (SO₄²⁻).

In an embodiment, the one or more minerals recovered using the NF membrane may include at least one of magnesium (Mg²⁺), and calcium (Ca²⁺).

In an embodiment, the apparatus further includes a reverse osmosis (RO) membrane unit. The one or more processors may be further configured to control the RO membrane unit to output a RO brine stream by passing seawater through a RO membrane. The seawater may include a plurality of chemical compounds. The seawater passes through the RO membrane to output at least a RO permeate stream and the RO brine stream. The RO brine stream comprises the first set of minerals from the plurality of chemical compounds.

In an embodiment, the plurality of chemical compounds may include salts, minerals, and chemical residues.

In an embodiment, the liquid stream is one of: seawater, or the RO brine stream.

In yet another aspect, a method for recovering minerals using an NF membrane is provided. The method may include controlling an inlet to receive a liquid stream including a first set of minerals. The method may further include controlling a recovery unit to recover one or more minerals from the first set of minerals by passing the liquid stream through the NF membrane. The NF membrane may have a positive surface charge that repels the one or more minerals for recovery. The liquid stream is passed through the NF membrane to output at least a NF permeate stream and a NF retentate stream, such that the NF retentate stream includes the one or more minerals. The method may further include controlling an outlet to output the NF retentate stream that includes the one or more minerals to recover the one or more minerals.

Further features and advantages will become more readily apparent from the following detailed description when taken in conjunction with the accompanying drawings.

### BRIEF DESCRIPTION OF DRAWINGS

Having thus described example embodiments of the disclosure in general terms, reference will now be made to the accompanying drawings, which are not necessarily drawn to scale, and wherein:

FIG. 1 illustrates a diagram of a network environment within which an apparatus for recovering minerals using an NF membrane is implemented, in accordance with an embodiment of the present disclosure;

FIG. 2 illustrates a block diagram of the apparatus of FIG. 1, in accordance with an embodiment of the present disclosure;

FIG. 3 illustrates a schematic diagram of the NF membrane, in accordance with an embodiment of the present disclosure;

FIG. 4 illustrates a block diagram of exemplary operations for recovering minerals using the NF membrane, in accordance with an embodiment of the present disclosure;

FIG. 5 illustrates a flowchart of an exemplary method for fabricating the NF membrane, in accordance with an embodiment of the present disclosure; and

FIG. 6 illustrates a flowchart of an exemplary method for recovering minerals using the NF membrane, in accordance with an embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatus and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

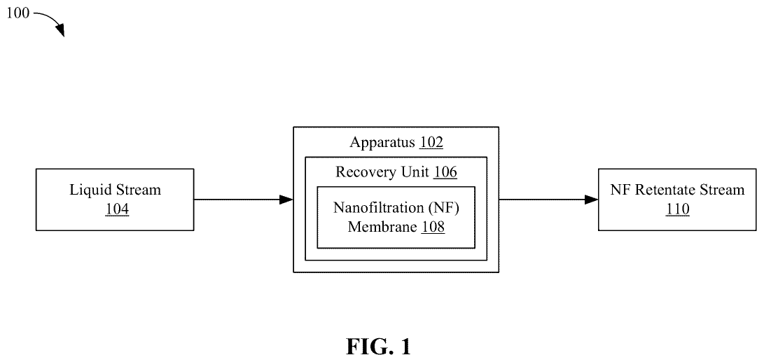

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 6, a brief description concerning the various components of the present disclosure will now be briefly discussed. Reference will be made to the figures, showing various embodiments of an apparatus for recovering minerals using metal-organic framework based nanofiltration membrane.

FIG. 1 illustrates a diagram of a network environment 100 within which an apparatus 102 for recovering minerals using a metal-organic-framework based NF membrane 108 is implemented, in accordance with an embodiment of the present disclosure. The apparatus 102 may further include a recovery unit 106 that includes the NF membrane 108.

The apparatus 102 is configured to perform the operation for recovering minerals from a liquid stream 104. Specifically, the apparatus 102 focuses on recovering minerals from concentrated brines of desalination plant and/or seawater. The apparatus 102 may employ the recovery unit 106 to recover the minerals. The recovery unit 106 may employ a Zero Liquid Discharge (ZLD) or a Minimum Liquid Discharge (MLD) based solutions for extracting minerals.

The ZLD or MLD may correspond to specifically curated water treatment processes designed to eliminate liquid waste for the desalination plant, thereby producing no or minimal discharge of wastewater to environment. The ZLD or MLD focuses on recovering or recycling all the water, thereby leaving behind only solid waste (for example, minerals) that may be disposed of or reused. Further, the ZLD or MLD based solutions may include an integration of membrane-based technologies and thermal-based technologies to recover resources, such as water, minerals and/or energy. In this manner, the ZLD based solutions focusses on reducing a volume of waste discharged to the aquatic ecosystem.

In an example, the ZLD or MLD based solutions for extracting minerals may include a nanofiltration (NF) membrane technology. The NF membrane 108 may be configured to enhance an efficiency of downstream technologies in the ZLD or MLD based solutions to recover the resources from the liquid stream 104.

In an embodiment, the NF membrane 108 may be a flat-sheet NF membrane that may be configured to selectively reject minerals, such as magnesium (Mg²⁺) and calcium (Ca²⁺) from the liquid stream 104. The NF membrane 108 disclosed in the present disclosure aims to enable high selectivity for certain minerals, namely, magnesium and calcium with respect to other ions, for example, sodium, chlorides, and sulphates, which may be present in the liquid stream 104.

In operation the apparatus 102 may be configured to control an inlet to receive the liquid stream 104 including a first set of minerals. The first set of minerals may include, but is not limited to, magnesium (Mg²⁺), calcium (Ca²⁺), sodium (Na⁺), chloride (Cl⁻), and sulphates (SO₄²⁻). The liquid stream 104 may be, for example, concentrated brine, seawater, or saltwater. The inlet may be controlled or operated to receive the liquid stream 104 from an input feed. Examples of the inlet may include, but is not limited to, a storage tank, an open inlet, and open seawater intake pipe.

Further, the apparatus 102 may be configured to control the recovery unit 106 to recover one or more minerals from the first set of minerals by passing the liquid stream 104 through the NF membrane 108. In this regard, the liquid stream 104 is passed through the NF membrane 108 to output at least an NF permeate stream and an NF retentate stream 110. The NF permeate stream may correspond to a portion of the liquid stream 104 that passes through the NF membrane 108. The NF permeate stream may include salts and organic molecules that may pass through the NF membrane 108. Further, the NF permeate stream may correspond to a purified liquid stream including very low concentration of dissolved contaminants or divalent ions (positively charged ions), for example, magnesium and calcium. The NF retentate stream 110 may correspond to a remaining portion of the liquid stream 104 that does not pass through the NF membrane 108. The NF retentate stream 110 may include salts and organic molecules that may not pass through the NF membrane 108. Further, the NF retentate stream 110 may correspond to a concentrated stream including very high concentration of dissolved contaminants or divalent ions (positively charged ions), for example, magnesium and calcium. For example, the NF membrane 108 is designed or arranged to have a positive surface charge. This positive surface charge repels the one or more minerals from the first set of minerals for minerals recovery. The one or more minerals may include positively charged ions of minerals, such as magnesium (Mg²⁺), and calcium (Ca²⁺).

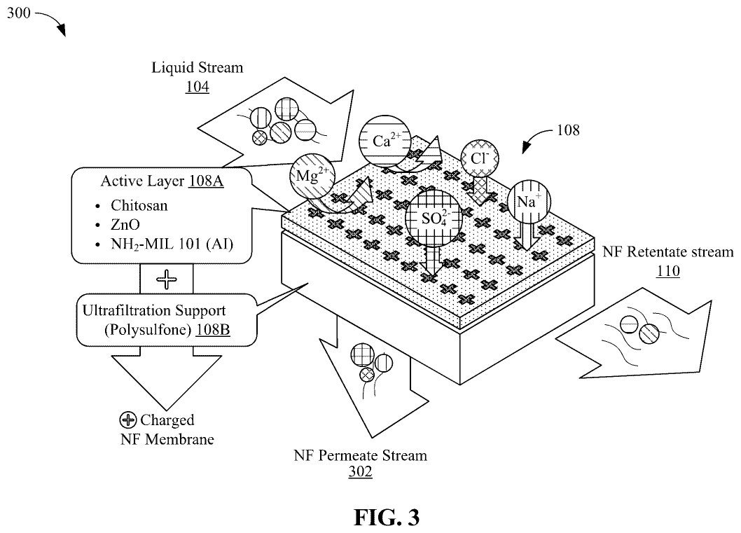

According to embodiments of the present disclosure, the NF membrane 108 includes a first layer and a second layer. In an example, the first layer of the NF membrane 108 has the positive surface charge that selectively repels the one or more minerals present in the liquid stream 104 when passed through the NF membrane 108. Additionally, the second layer of the NF membrane 108 may provide mechanical support to the first layer. Details associated with the fabrication of the NF membrane 108 are provided in conjunction with, for example, FIG. 3.

In an embodiment, the apparatus 102 may be configured to control an outlet to output the NF retentate stream 110. The NF retentate stream 110 may include the one or more minerals to recover the one or more minerals. In an example, the apparatus 102 may be configured to control a storage unit to store the recovered one or more minerals. The stored one or more minerals may be used for industrial purposes, pharmaceutical production, commercial use, residential use, and the like. In another example the recovered one or more minerals can further be sent to another unit to perform other functions and/or downstream operations.

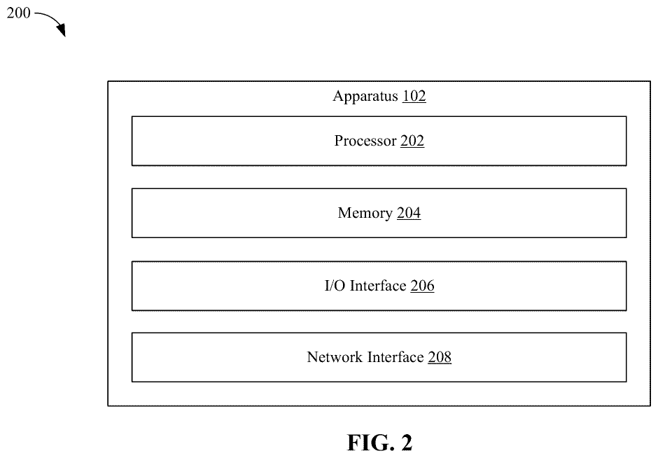

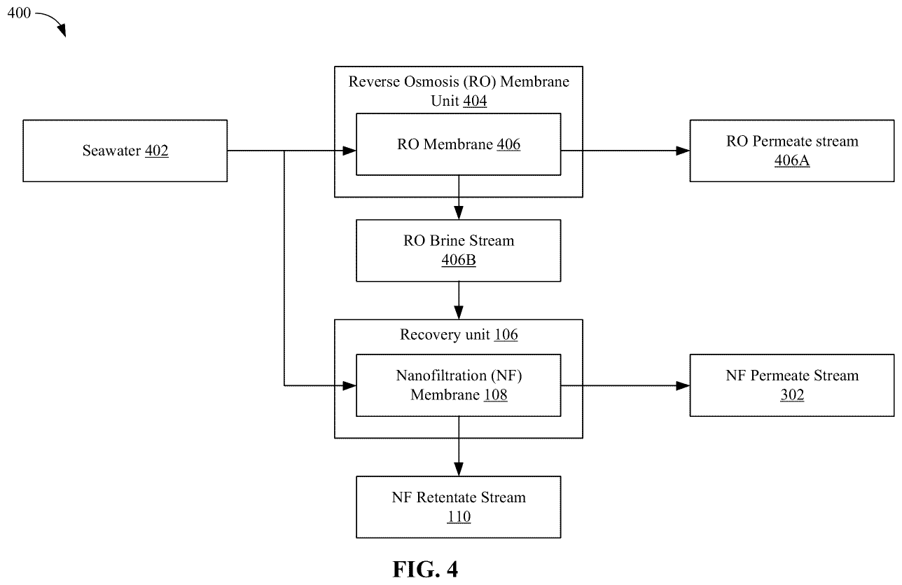

The functions or operations executed by the apparatus 102 are further described in detail in conjunction with, for example, FIG. 2, FIG. 3 and FIG. 4.

FIG. 2 illustrates a block diagram 200 of the apparatus 102, in accordance with an embodiment of the disclosure. The apparatus 102 may include at least one processor (referred to as a processor 202, hereinafter), at least one non-transitory memory (referred to as a memory 204, hereinafter), an input/output (I/O) interface 206, and a network interface 208. The processor 202 may be connected to the memory 204, the I/O interface 206, and the network interface 208 through one or more wired or wireless connections. Although in FIG. 2, it is shown that the apparatus 102 includes the processor 202, the memory 204, the I/O interface 206, and the network interface 208, however, the disclosure may not be so limiting and the apparatus 102 may include fewer or more components to perform the same or other functions of the apparatus 102.

The processor 202 of the apparatus 102 may be configured to perform one or more operations associated with the recovery of minerals using the metal-organic-framework-based NF membrane 108. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the apparatus 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The communication network may be accessed using the network interface 208 of the apparatus 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the apparatus 102 to carry out various functions in accordance with an example embodiment of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein.

In some example embodiments, the I/O interface 206 may communicate with the apparatus 102 and display input and/or output of the apparatus 102. As such, the I/O interface 206 may include a display and, in some embodiments, may also include a keyboard, a mouse, a touch screen, touch areas, soft keys, or other input/output mechanisms. In one embodiment, the apparatus 102 may include a user interface circuitry configured to control at least some functions of one or more I/O interface elements such as a display and, in some embodiments, a plurality of speakers, a ringer, one or more microphones and/or the like. The processor 202 and/or I/O interface 206 circuitry including the processor 202 may be configured to control one or more functions of one or more I/O interface 206 elements through computer program instructions (for example, software and/or firmware) stored on a memory 204 accessible to the processor 202.

The network interface 208 may include an interface for supporting communications to and from the apparatus 102 or any other component with which the apparatus 102 may communicate. The network interface 208 may be any means, such as a device or circuitry embodied in either hardware or a combination of hardware and software that is configured to receive and/or transmit data to/from a communications device in communication with the apparatus 102. In this regard, the network interface 208 may include, for example, an antenna (or multiple antennae) and supporting hardware and/or software for enabling communications with a wireless communication network. Additionally, or alternatively, the Network interface 208 may include the circuitry for interacting with the antenna(s) to cause transmission of signals via the antenna(s) or to handle receipt of signals received via the antenna(s). In some environments, the network interface 208 may alternatively or additionally support wired communication. As such, for example, the network interface 208 may include a communication modem and/or other hardware and/or software for supporting communication via cable, digital subscriber line (DSL), universal serial bus (USB), or other mechanisms.

According to the present disclosure, the processor 202 is configured to control the inlet to receive the liquid stream 104 including the first set of minerals. Further, the processor may be configured to control the recovery unit 106 to recover the one or more minerals from the first set of minerals by passing the liquid stream 104 through the NF membrane 108. The NF membrane may be designed to have a positive surface charge. This positive surface charge repels the one or more minerals from the first set of minerals for minerals recovery. The one or more minerals may include positively charged ions of minerals, such as for magnesium (Mg²⁺), and calcium (Ca²⁺). Further, the liquid stream 104 passes through the NF membrane 108 to output the NF permeate stream and the NF retentate stream 110. The NF retentate stream 110 includes the one or more minerals. Thereafter, the processor 202 may be further configured to control the outlet to output the NF retentate stream 110 including the one or more minerals to recover the one or more minerals.

FIG. 3 illustrates a schematic diagram 300 of the NF membrane 108, in accordance with an embodiment of the disclosure. FIG. 3 is explained in conjunction with FIG. 1 and FIG. 2. The NF membrane 108 may include a first layer 108A, and a second layer 108B.

In particular, the NF membrane 108 is configured to enhance selective multi-cationic recovery, such as selectivity for magnesium and calcium. The NF membrane 108 may be made of low-cost materials, such as an ultrafiltration (UF) substrate and an active layer.

In an embodiment, the first layer 108A may be implemented by a synthesized active layer. The first layer 108A is made of three main low-cost components to selectively reject resources, such as magnesium and calcium from the liquid stream 104. As may be understood, to reach such high selectivity in rejection of magnesium (Mg²⁺) and Calcium (Ca²⁺), it is required for the first layer 108A to have a positive surface charge. Therefore, the first layer 108A (or the active layer) may be made of a Metal Organic Framework (MOF), metal oxide nanoparticles, and a chitosan matrix. In an example, the main components of the first layer 108A may include a positively charged MOF, highly hydrophilic metal oxide nanoparticles or Nano filler, and a chitosan matrix. This makes the NF membrane 108 more economical, environment-friendly, and resistant to contamination. Moreover, the materials used for the NF membrane 108 show an intrinsic permeability, this means that the NF membrane 108, when fabricated in thin layers can be much more productive than other commercial membranes.

The MOF is a type of advanced material made up of metal ions or clusters connected by organic molecules. Such a structure may create highly porous networks, which may have a vast internal surface area. Further, the MOFs are known for their ability to store, separate, and transport gases and liquids, thereby making them useful in various applications such as gas storage, catalysis, and drug delivery. Additionally, the MOF are customizable in nature, thereby allowing scientists to design MOFs with specific properties tailored to particular needs.

The metal oxide nanoparticles or nano filler are tiny particles composed of metal oxides, with sizes typically ranging from 1 to 100 nanometers. Such nanoparticles exhibit unique physical and chemical properties due to their small size and high surface area. Examples of the metal oxide nanoparticles may include but are not limited to titanium dioxide (TiO₂), zinc oxide (ZnO), and iron oxide (Fe₂O₃) nanoparticles. Further, the metal oxide nanoparticles are used in a wide range of applications, including, but not limited to catalysis, sunscreens, medical applications, environmental remediation, and electronics. For example, the metal oxide nanoparticles may be employed in catalysis to enhance chemical reactions due to their high surface area and reactivity. In an example, the metal oxide nanoparticles may be utilized in sunscreens to provide ultraviolet (UV) protection due to their ability to absorb and scatter ultraviolet light. In another example, the metal oxide nanoparticles may serve as contrast agents in imaging or as carriers for drug delivery in various medical applications. In yet another example, the metal oxide nanoparticles may help in removal of pollutants from water and air. Further, the metal oxide nanoparticles may be utilized in electronics to improve the performance of sensors, batteries, and other electronic devices.

Further, the MOF and the metal oxide nanoparticles may provide the positive charge to the first layer 108A. Specifically, the MOF increases the surface area of the NF membrane 108 due to the structure of the MOF that may create highly porous network. Moreover, the metal oxide nanoparticles may increase an affinity of the NF membrane 108 to water, i.e., hydrophilicity, of the NF membrane 108.

In an example, the MOF may correspond to an amino-functionalized Material Institute Lavoisier (MIL)-101, specifically NH₂-MIL-101 (A1). Such MOF derives from the MIL-101 family. The amino-functionalized MIL-101 refers to a type of the MOF that has been modified to include amino groups (—NH₂). The MIL-101 itself is a well-known MOF composed of chromium (III) ions and benzene-1,4-dicarboxylate linkers, creating a highly porous structure with exceptional stability and large surface area. When the amino groups are introduced to MIL-101, either by incorporating amino-functionalized organic linkers during synthesis or by post-synthetic modification, the resulting material gains additional chemical functionalities. These amino groups can enhance the MOF's properties and expand its potential applications. For example, the amino-functionalized MIL-101 can absorb heavy metals and other contaminants more effectively, thereby improving performance of water treatment plant (or the desalination plant).

Further, the MOF NH₂-MIL-101 (A1) has a high specific surface area and micro-porosity, and therefore provides a good mixing with the other components of the first layer 108A and increases the positive surface charge of the NF membrane 108. Further, the metal oxide nanoparticles may correspond to zinc oxide (ZnO) nanoparticles due to their positive charge within a wide range of pH and hydrophilic properties. The materials of the first layer 108A, such as the metal-organic framework (MOF) and the metal oxide nanoparticles may be low cost and provide the NF membrane 108 with a high positive membrane surface charge to selectively reject magnesium and calcium. In an example, the NF membrane 108 may be optimized via different loading of ZnO/NH₂-MIL-101 (A1) within the first layer 108A.

The chitosan matrix is a structure or framework made from chitosan, a natural polysaccharide derived from chitin, which is found in the exoskeletons of crustaceans like shrimp and crabs. The chitosan is known for its biocompatibility, biodegradability, and non-toxicity, making it an attractive material for various applications. Further, the term “matrix” in this context refers to a scaffold or network that can support the incorporation and distribution of other materials or active substances. The chitosan matrix may be used in several fields due to their versatile properties. For example, the chitosan matrix may be utilized in the removal of heavy metals and pollutants from water due to its high adsorption capacity.

In an embodiment, the second layer 108B may be made of a polysulfone Ultra-filtration (UF) substrate. The second layer 108B provides mechanical support to an overall structure of the NF membrane 108. In an example, the second layer 108B is a highly permeable polysulfone UF substrate.

In an example, for fabricating the NF membrane 108, the first layer 108A is prepared as a coating solution. The coating solution of the first layer 108A may include a chitosan, an acid solution, one or more metal oxide nanoparticles and a Metal Organic Framework (MOF). In an example, a composition of the first layer 108A may include, for example, a first predefined amount of chitosan matrix. Further, composition of the first layer 108A may include, for example, a second predefined amount of metal oxide or ZnO nanoparticles, and a third predefined amount of MOF. Such composition of the first layer 108A shows an intrinsic permeability (i.e., permeability of the composition of the first layer itself and not of the NF membrane 112) in a range of, for example, 40 and 100 (L/(m²·h·bar))·μm.

Further, the first layer 108A that is made of MOF, ZnO nanoparticles, and the chitosan matrix provides anti-bacterial properties that require less maintenance and mitigates risk of contamination of NF retentate stream 110, i.e., Mg²⁺ and Ca²⁺. The chitosan may function as a binder between the first layer 108A, i.e., active layer, and the second layer 108B, i.e., UF substrate. Further, the chitosan is low-cost, biodegradable and an anti-microbial material. Therefore, such anti-microbial properties may allow the use of the NF membrane 108 in photocatalytic applications. Further, the NF membrane 108 may recover magnesium and calcium from the liquid stream 104 that includes pollutants that may potentially harm the desalination membrane.

In the exemplary embodiment, dispersion for the coating solution may be further prepared by dissolving the chitosan in an aqueous acetic acid, for example, 20% wt of chitosan may be dissolved in 2% wt of the aqueous acid solution. Then, zinc oxide (ZnO) Nano powder and the MOF may be gradually added to the chitosan solution under stirring conditions. For example, the coating solution may be magnetically stirred for 24 hours to guarantee a homogenous coating. Further, the coating solution may be then subjected to an ultrasonic bath for 30 minutes to remove all gas that could compromise the coating procedure. In an example, the second layer 108B coated with the coating solution to form the first layer 108A may be set to dry in a static oven at 80° C. for 2 hours to complete the solvent evaporation process and consolidate the active layer.

In the exemplary embodiment, the NH₂-MIL-101 (A1) fabrication is carried out by means of the solvothermal method easily understood by the person skilled in the art. According to such procedure, 0.51 gram (g) of AlCl₃·6H₂O and 0.56 g of 2-aminoterephthalic acid are physically mixed in 30 milliliters (mL) of DMF and stirred for 30 minutes. The solution is then placed in a Teflon-lined autoclave and heated in a static oven for 72 hours at 130° C. Subsequently, once cooled to room temperature, the resulting yellow powder is vacuum filtered and washed 3 times with acetone. An activation process of the remaining powder is performed by refluxing the MOF with boiling methanol overnight to remove residual organic species still trapped within the pores. The MOF is then dried in a static oven for 16 hours at 200° C.

In an example, the MOF, specifically, nanocrystals of the MOF are manufactured or synthesized using, for example, 2-aminoterephthalic acid, AlCl₃·6H₂O and dimethylformamide (DMF). Further, acetone and methanol may be used for washing the nanocrystals of the MOF. In an example, the chitosan matrix having medium molecular weight, ZnO nano powder having particle size in Nanometers (nm), say less than 100 nm, and acetic acid may be employed for the synthesis of the coating solution for forming the first layer 108A of the NF membrane 108. Moreover, deionized water with predetermined resistivity may be employed throughout MOF syntheses, membrane fabrication, and the preparation of salt solutions for all the filtration tests.

In an example, the synthesis of the NH₂-MIL-101 (A1) MOF matrix is performed using the solvothermal method. In such a case, for example, AlCl₃·6H₂O and 2-aminoterephthalic acid are physically mixed in DMF and stirred for a predefined time period. The solution may then be placed in a Teflon-lined autoclave and heated in a static oven for another predefined time period at a predefined temperature. Subsequently, once cooled to room temperature, the resulting yellow powder may be vacuum filtered and washed with acetone. An activation process of the remaining powder may be performed by refluxing the remaining powder with boiling methanol to remove residual organic species still trapped within the pores. The MOF nanocrystals are thus synthesized after drying in a static oven for a certain amount of time at a predefined temperature.

It may be noted that chemical compounds and synthesis process described above is only exemplary and should not be construed as a limitation. Further, alternate, or different chemical compounds showing similar or same physical and/or chemical properties and alternate synthesis process may also be employed for synthesizing the coating solution for the first layer 108A.

In an embodiment, the second layer 108B may be pretreated by immersing the second layer 108B into a base solution to activate a substrate surface of the second layer 108B. In an example the second layer 108B of the NF membrane 108 may be made of UF substrate and may be referred to as a substrate layer. The UF substrate refers to an ultrafiltration (UF) membrane substrate. The UF is a type of membrane filtration process where a semipermeable membrane (UF membrane) may be used to separate particles and solutes in the liquid stream based on size. The term “substrate” in this context refers to the underlying material or layer on which the UF membrane is built or applied. The UF membranes have pore sizes typically ranging from 1 to 100 nanometers, thereby allowing them to effectively remove macromolecules, such as proteins and large organic molecules, from a solution. Further, the UF substrate can be made from various materials, including for example, but not limited to, polymers (like polysulfone, polyethersulfone, and polyvinylidene fluoride) or ceramics. The material of the UF substrate may vary based on specific application and required properties. In an example, the UF membranes are widely used in the water treatment plant for purifying drinking water. In such an example, the UF membranes may be employed in a pre-treatment step of the water treatment plant (or the desalination plant), thereby treating wastewater.

In an embodiment, the UF substrate provides mechanical support to the ultrafiltration membrane and can influence its performance characteristics, such as permeability, selectivity, and chemical resistance. In an example, the UF substrate may be a UF polysulfone (PSF) membrane with a predefined molecular weight cut-off. In another example, the second layer 108B may be pre-treated via immersion in the base solution (for example, but not limited to, NaOH solution) of a predefined molarity for a predefined time period to activate a substrate surface of the second layer 108B for facilitating a bonding between the second layer 108B and the first layer 108A. The immersion may also remove any glycerin present in pores of the second layer 108B. Subsequently, the pre-treated second layer 108B may be then rinsed, for example, 2 to 5 times, with deionized water. Once the pre-treatment of the second layer 108B may be completed, it may be used for fabricating the NF membrane 108. In an example, a thickness of the UF substrate may be 200 microns. In another example, the thickness of the UF substate may be in a range of 200 microns to 400 microns.

In an embodiment, the NF membrane 108 may be fabricated by coating the second layer 108B with the coating solution, such that the coating solution forms the first layer 108A on the second layer 108B. The first layer 108A has a positive surface charge to selectively repel the one or more minerals from the liquid stream 104, via Donnan exclusion mechanism. The Donnan exclusion mechanism may correspond to the Donnan effect or Donnan equilibrium. The Donnan effect is a phenomenon that occurs when ionic compounds distribute unevenly across the semi-permeable membrane due to presence of a non-permeable charged substance (for example, polyelectrolyte) on one side of the semi-permeable membrane. The Donnan effect is utilized for selective ion removal at the NF membrane 108 during the water treatment process.

In an example, the coating solution of the first layer 108A may be coated on the second layer 108B to fabricate the NF membrane 108. In an example, the NF membrane 108 may be prepared by solvent-casting process. In this regard, the coating solution of the first layer 108A may be solvent-casted on the second layer 108B via a spiral bar-coater, i.e., the second layer 108B may be coated with the coating solution. The coated NF membrane 108 may be then set to dry in a static oven at a predefined temperature for a predefined time period to complete the solvent evaporation process and consolidate the first layer 108A.

The proposed method for fabricating the NF membrane 108 includes fabricating the second layer 108B or the UF substrate, preparing the coating solution for the first layer 108A or active layer of the NF membrane 108, and fabricating the NF membrane 108. In an example, a solution casting process may be utilized as a fabrication technique for fabricating the NF membrane 108, thereby reducing overall cost of the NF membrane 108. Further, the proposed composition of the NF membrane 108 presents high zeta potential values in a wide pH range, thereby providing a higher overall positive surface charge of the NF membrane 108. The positively charged NF membrane 108 is synthesized to valorize seawater and concentrated brines.

In an operation, the NF membrane 108 may receive the liquid stream 104 which can be seawater or concentrated brine stream from a RO membrane unit of a SWRO system. Details of the SWRO are described in conjunction with, for example, FIG. 4.

The liquid stream 104 may pass through the NF membrane 108. Subsequently, the NF membrane 108 may output a NF permeate stream 302 and a NF retentate stream 110. The NF retentate stream may include for example, but not limited to magnesium (Mg²⁺), and calcium (Ca²⁺). In an example, the NF membrane 108 may produce the NF retentate stream 110 that may be rich in magnesium and calcium and poor in sulphates. The rejected magnesium and calcium are then recovered using downstream crystallization technologies, further described, for example, in FIG. 4.

FIG. 4 illustrates a block diagram 400 of exemplary operations for recovering minerals using the NF membrane 108, in accordance with an embodiment of the present disclosure. FIG. 4 is explained in conjunction with FIG. 1, FIG. 2, and FIG. 3. The operations may be executed by any computing system, for example, by the apparatus 102 of FIG. 1 or the processor 202 of FIG. 2.

In an embodiment, the apparatus 102 may be configured to optimize mineral extraction in the SWRO process. The seawater reverse osmosis technique may employ a use of semi-permeable membranes that allows a solvent to pass through, while restricting solutes (such as impurities), leading to separation of salt and the freshwater.

In an embodiment, seawater 402 may be provided as an input or feed to an RO membrane unit 404. The RO membrane unit 404 is configured to receive the seawater 402 from various sources. Examples of such sources may include, but are not limited to, a storage tank, an open inlet, an open seawater intake pipe, and a beach well. For example, a Total Dissolved Solids (TDS) value for the liquid stream 104 or the seawater 402 may range from 37,000 to 50,000 milligrams per liter (mg/l). Further, a Potential of Hydrogen (pH) value of the seawater 402 may lie within a range of 7 to 8.6. Additionally, the seawater 402 may have a high salt content, thereby making the seawater 402 unsafe for human use.

Typically, a seawater desalination technique may be employed to obtain filtered liquid stream (such as freshwater, permeate water, or potable water) by removing excessive salt content from the seawater 402. Examples of various methods of treatment of the seawater desalination may include, but are not limited to, evaporation of seawater 402 and a membrane separation method based on differential and selective permeation ability of the membrane. For example, the membrane separation method may correspond to a RO process. The RO process may refer to a technique by which the freshwater may be extracted from the seawater 402. In the RO process a pressure higher than osmotic pressure of the seawater 402 may be applied on the seawater 402, thereby allowing a portion of the seawater 402 (for example, RO permeate stream) to pass through a semipermeable membrane. The SWRO technique may employ the use of semi-permeable membranes that allow a solvent to pass through, while restricting solutes (such as impurities), leading to the separation of salt and freshwater.

In an operation, the apparatus 102 may be further configured to control the RO membrane unit 404 to pass the seawater 402 through a RO membrane 406 to output a RO brine stream 406B and/or a RO permeate stream 406A. The RO permeate stream 406A may correspond to a portion of the liquid stream 104 that passes through the RO membrane 406. The RO permeate stream may include low concentration of solutes that may pass through the RO membrane 406. Further, the RO permeate stream may correspond to a purified liquid stream including very low concentration of dissolved contaminants or divalent ions (positively charged ions) for example, magnesium and calcium. The RO brine stream 406B may correspond to a remaining portion of the liquid stream 104 that does not pass through the RO membrane 406. The RO brine stream 406B may include salts and organic molecules that may not pass through the RO membrane 406. Further, the RO brine stream 406B may correspond to a concentrated stream including very high concentration of dissolved contaminants or divalent ions (positively charged ions) for example, magnesium and calcium.

The seawater 402 may include a plurality of chemical compounds, for example, but is not limited to salts, minerals, and chemical residues. The RO membrane unit 404 may remove impurities from the received seawater 402 by passing the seawater 402 through the RO membrane 406. Examples of the RO membrane 406 may include, but are not limited to, a spiral wound RO membrane, or a hollow fiber RO membrane. The RO permeate stream 406A may be high quality freshwater that may be fit for consumption. To this end, the RO brine stream 406B may be waste of the seawater RO process. Such concentrated RO brine stream 406B may include a large number of resources and minerals. The RO brine stream 406B may include a plurality of minerals. The plurality of minerals may further include the first set of minerals, for example, but not limited to, magnesium (Mg²⁺), calcium (Ca²⁺), sodium (Na⁺), chloride (Cl⁻), and sulphates (SO₄²⁻). The RO brine stream 406B may be passed through the recovery unit 106 to recover the minerals.

In an embodiment, RO brine stream 406B may be passed through the recovery unit 106 to recover the one or more minerals, for example, but not limited to, magnesium (Mg²⁺), and calcium (Ca²⁺). The liquid stream 104 may correspond to, for example, the seawater 402 or the RO brine stream 406B discharged from the RO membrane unit 404.

In an embodiment, the recovery unit 106 may include the NF membrane 108. The liquid stream 104, i.e., the seawater 402 or the RO brine stream 406B, may be passed through the NF membrane 108 to generate the NF permeate stream 302 and the NF retentate stream 110. The recovery unit 106 may be used for enhancing the efficiency of downstream technologies to recover resources, such as minerals from the seawater 402 and/or the RO brine stream 406B. Examples of the recovery unit 106 may include, but is not limited to, Zero Liquid Discharge (ZLD) based-unit or Minimum Liquid Discharge (MLD) based-unit. In this regard, membrane-based technologies may be used for recovering the resources. Specifically, Nano-filtration (NF) technology or NF membrane 108 is used for recovering resources or minerals from the seawater 402 and/or the RO brine stream 406B. The NF membrane 108 may be a pressure-driven membrane process with selectivity between RO and ultrafiltration (UF). NF membranes may have a pore-size in the range of, for example, 0.5 nm to 2 nm. For example, NF membrane 108 when combined with steric exclusion, the Donnan exclusion and dielectric exclusion provide high selectively towards multi-valent ions. Moreover, due to features of NF membranes, such as low operating pressure, low energy consumption and high separation selectivity, the NF membranes serve as a good option for a pre-treatment step for ZLD and/or MLD based units. However, current convention NF membranes fail to achieve desired purity of recovered minerals, making ZLD or MLD currently economically unfeasible.

Typically, NF membranes present high rejection performances towards all multivalent ions (i.e., Mg²⁺, Ca²⁺, SO₄²⁻, etc.). Therefore, if magnesium was to be recovered via a downstream crystallization step, the recovered magnesium product may not be at par with required market standards due to the presence of impurities. Therefore, mineral recovery from the seawater 402 and/or the RO brine stream 406B would not be economically feasible by using only conventional NF membranes within a pre-treatment step. Moreover, addition of intermediate separation processes for recovering more pure elements or resources would lead to increase of both capital and operating costs, thereby further affecting economic feasibility of the recovered resources.

This would allow increasing the efficiency of the downstream crystallization steps by reducing a number of intermediate separation technologies within the recovery unit 106, such as the MLD or the ZLD processes. Furthermore, the NF membrane 108 may allow achieving high purity products, contributing to the economic feasibility of the recovery unit 106. If MLD or ZLD process were to be economic feasible, highly pure resources or minerals could be recovered from waste brines or concentrated brines of desalination plants leading to higher mineral availability when compared to land mining, reduced volume of brine discharged back to the environment, and reduced cost of brine treatment for desalination plants due to sale of recovered minerals.

In certain cases, a conventional positively charged NF membrane 108 may be used in the recovery unit 106. Such conventional positively charged NF membrane 108 may, via electric expulsion, allow rejecting of multi-valent cations. As a result, sulphates would also be rejected and may permeate across the conventional NF membrane, along with sodium and chloride ions. However, all the conventional NF membranes have only been tested with single salt solutions at very low concentration. Therefore, their performances in multi-ionic solutions or real solutions are completely unknown, may be instable or have poor performances. Concerning single salt solution testing, some membranes present high rejections towards all ions, thus low magnesium selectivity, behaving as the RO membrane unit 404. Other proposed membranes, on the other hand, present lower rejections towards magnesium and calcium. Furthermore, the conventional membranes are made of certain materials that have a significantly higher cost thereby increasing overall cost of the NF membrane 108 and cost of recovery.

The disclosed NF membrane 108 provides high selectivity when treating alkaline solutions, such as the seawater 402 and/or the RO brine stream 406B. The NF membrane 108 may be in form of a flat sheet that is configured to selectively reject resources, such as magnesium and calcium from the seawater 402 and/or the RO brine stream 406B. The NF membrane 108 disclosed in the present disclosure aims to enable high selectivity for magnesium and calcium with respect to other ions, for example, sodium, chlorides, and sulphates, which may be present in the seawater 402 and/or the RO brine stream 406B.

In an example, the NF membrane 108, when tested with single solutions of predefined concentration or parts per million (ppm) of sodium chloride (NaCl), calcium chloride (CaCl₂), magnesium chloride (MgCl₂), and sodium sulphate (Na₂SO₄) at a predefined pressure, provides high rejection towards MgCl₂ and CaCl₂. For example, rejection for MgCl₂ is greater than 90% and rejection for CaCl₂ is greater than 80%. Furthermore, the NF membrane 108, when tested with synthetic seawater and brine solutions at a predefined pressure, provides high selectivity of the NF membrane 108 for rejection towards Mg²⁺.

Further, the repulsion of one or minerals due to positive surface charge is further governed by Donnan effect easily understood by the person skilled in the art. The Donnan membrane concept is founded on the Donnan co-ion exclusion phenomenon, which states that anions will be rejected by negatively charged cation exchange membranes whereas cations will be rejected by positively charged anion exchange membranes. The Donnan membrane principle, in contrast to other membrane processes, works by virtue of the electrochemical potential difference between electrolytes on two sides of an ion exchange membrane and does not require a pressure gradient or an electric current source. As per the Donnan effect, given that the NF membranes present a positive surface charge and that Mg²⁺, and Ca²⁺ present a larger charge density than Na⁺, the multivalent cations present a higher rejection than Na⁺. Utilizing the Donnan effect, which promotes electrochemical potential equilibrium between two solutions divided by an ion exchange membrane, the current invention recovers nutrients.

In an exemplary embodiment, the NF retentate stream 110 containing the one or more minerals from the NF membrane 108 may be further passed through the downstream crystallization unit. The one or more minerals from the NF membrane 108 is first concentrated in the downstream crystallization unit using one of the technologies from the group consisting of humidification-dehumidification, forward osmosis, and vibratory osmosis. Additionally, the output from the NF membrane 108 that has been concentrated to the maximum in the preceding steps is around the point of saturation in which the precipitation of the minerals that are mostly present in the liquid effluent begins to occur. In this the downstream crystallization unit acts as a crystallizer. A stream of solids is recovered by evaporation as an output. It may be noted that the process described above is only exemplary and should not be construed as a limitation.

In one embodiment, the output from the downstream crystallization unit may be stored, for example, in a storage tank or a container. The stored output may be used for residential use or other industrial processes.

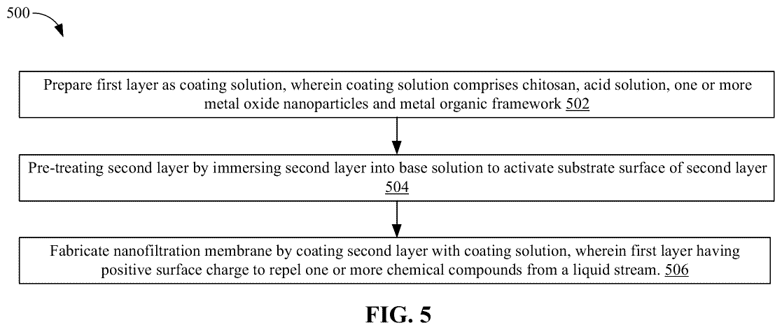

FIG. 5 illustrates a flowchart 500 of an exemplary method for fabricating the NF membrane 108, in accordance with an embodiment of the present disclosure. FIG. 5 is explained in conjunction with elements from FIG. 1, FIG. 2, FIG. 3, and FIG. 4. In an example, the operations of the exemplary method may be executed by any computing system, for example, by the apparatus 102 of FIG. 1 or the processor 202 of FIG. 2. The operations of the flowchart 500 may start at 502.

At 502, a coating solution is prepared. In an embodiment, the coating solution is prepared for forming the first layer 108A of the NF membrane 108. The coating solution may be prepared using, for example, chitosan, an acid solution, one or more metal oxide (such as ZnO) nanoparticles, and a Metal-Organic Framework (MOF). Details associated with the preparation of the first layer 108A are provided, for example, in FIG. 3.

At 504, the second layer 108B is pre-treated. In an embodiment, the second layer 108B may be pre-treated by immersing a substrate forming the second layer 108B into a base solution to activate a substrate surface. Details associated with the second layer 108B are provided, for example, in FIG. 3.

At 506, the NF membrane 108 is fabricated. In an embodiment, the NF membrane 108 is fabricated by coating the second layer 108B with the coating solution such that the coating solution forms the first layer 108A on the second layer 108B. As a result, the first layer 108A made of the coating solution has a positive surface charge to selectively repel one or more minerals from the liquid stream 104. The minerals repelled from the first layer may be, for example, calcium and magnesium. These repelled minerals may be accumulated for recovery thereof. Further, these recovered minerals may be treated and used in various downstream operations associated with, for example, cosmetics industry, construction industry, agricultural industry, chemical industry, metallurgical industry, healthcare and pharmaceuticals industry, food, and beverage industry, etc. Details associated with the fabrication of the NF membrane 108 are provided, for example, in FIG. 3.

Accordingly, blocks of the flowchart 500 support combinations of means for performing the specified functions and combinations of operations for performing the specified functions. It will also be understood that one or more blocks of the flowchart 500 can be implemented by special purpose hardware-based computer systems which perform the specified functions, or combinations of special purpose hardware and computer instructions.

Alternatively, the apparatus 102 may include means for performing each of the operations described above. In this regard, according to an example embodiment, examples of means for performing operations may include, for example, a processor and/or a device or circuit for executing instructions, such as the operations or instructions for fabricating the NF membrane 108.

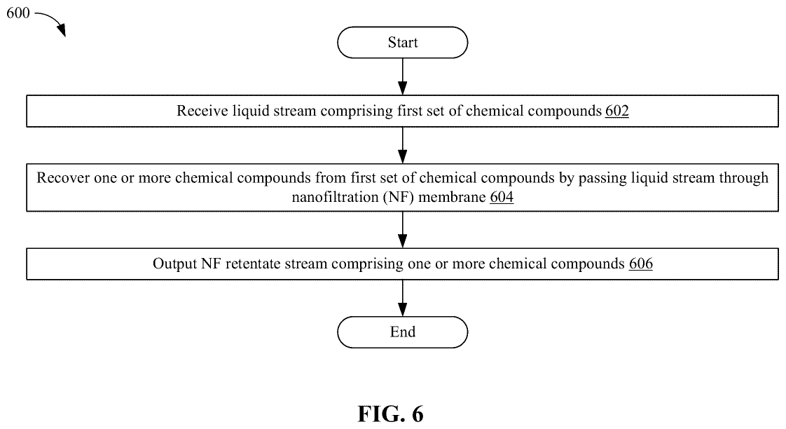

FIG. 6 illustrates a flowchart 600 of an exemplary method for recovering minerals, in accordance with an embodiment of the present disclosure. FIG. 6 is explained in conjunction with elements of FIG. 1, FIG. 2, FIG. 3, FIG. 4, and FIG. 5. The operations of the exemplary method may be executed by any computing system, for example, by the apparatus 102 of FIG. 1 or the processor 202 of FIG. 2. The operations of the flowchart 600 may start at 602.

At 602, the liquid stream 104 is received. In an embodiment, the processor 202 may be configured to control an inlet to receive the liquid stream 104. The liquid stream 104 may include a first set of minerals, such as magnesium (Mg²⁺), calcium (Ca²⁺), sodium (Na⁺), chloride (Cl⁻), and sulphates (SO₄²⁻). Details associated with the reception of the liquid stream 104 are provided, for example, in FIG. 1 and FIG. 4.

At 604, one or more minerals are recovered from the liquid stream 104. In an embodiment, the processor 202 may be configured to control the recovery unit 106 to recover the one or more minerals from the first set of minerals by passing the liquid stream 104 through the NF membrane 108. As the first layer 108A of the NF membrane 108 has a positive surface charge, it repels the one or more minerals for recovery. The liquid stream 104 may be passed through the NF membrane 108 to output the NF permeate stream 302 and the NF retentate stream 110. The NF permeate stream 302 may be devoid of the one or more minerals recovered by the NF membrane 108, while the NF retentate stream 110 may include the one or more minerals, such as magnesium (Mg²⁺), and calcium (Ca²⁺). Details associated with the recovery of one or minerals are provided, for example, in FIG. 3 and FIG. 4.

At 606, the NF retentate stream 110 may be recovered as an output. In an embodiment, the processor 202 may be configured to control an outlet to output the NF retentate stream 110 including the one or more minerals. Details associated with the recovery of the one or minerals are provided, for example, in FIG. 1, FIG. 3, and FIG. 4.

Alternatively, the apparatus 102 may include means for performing each of the operations described above. In this regard, according to an example embodiment, examples of means for performing operations may comprise, for example, the processor and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

What is claimed:

1. A method for fabricating a nanofiltration (NF) membrane, comprising:
preparing a first layer as a coating solution, the coating solution comprising chitosan, an acid solution, one or more metal oxide nanoparticles, and a Metal-Organic Framework (MOF);
pre-treating a second layer by immersing the second layer into a base solution to activate a substrate surface of the second layer; and
fabricating the NF membrane by coating the second layer with the coating solution, such that the coating solution forms the first layer on the second layer, the first layer having a positive surface charge to selectively repel one or more minerals from a liquid stream for recovery.

2. The method of claim 1, wherein the MOF comprises an amino-functionalized Material Institute Lavoisier (MIL)-101.

3. The method of claim 1, wherein the second layer is made of a polysulfone ultrafiltration (UF) substrate.

4. The method of claim 1, wherein the one or more minerals recovered using the NF membrane comprises at least one of: magnesium (Mg²⁺), and calcium (Ca²⁺).

5. An apparatus, comprising:
one or more processors configured to:
control an inlet to receive a liquid stream comprising a first set of minerals;
control a recovery unit to recover one or more minerals from the first set of minerals by passing the liquid stream through a nanofiltration (NF) membrane having a positive surface charge that repels the one or more minerals for recovery, wherein the liquid stream passes through the NF membrane to output at least: an NF permeate stream and an NF retentate stream comprising the one or more minerals; and
control an outlet to output the NF retentate stream comprising the one or more minerals to recover the one or more minerals.

6. The apparatus of claim 5, wherein the NF membrane comprises:
a first layer having the positive surface charge that selectively repels the one or more minerals for the recovery, and
a second layer to provide mechanical support to the first layer.

7. The apparatus of claim 6, wherein the first layer is made of a Metal-Organic Framework (MOF), metal oxide nanoparticles, and a chitosan matrix.

8. The apparatus of claim 7, wherein the MOF comprises an amino-functionalized Material Institute Lavoisier (MIL)-101.

9. The apparatus of claim 6, wherein the second layer is made of a polysulfone ultrafiltration (UF) substrate.

10. The apparatus of claim 5, wherein the first set of minerals comprises at least one of: magnesium (Mg²⁺), calcium (Ca²⁺), sodium (Na⁺), chloride (Cl⁻), and sulphates (SO₄²⁻).

11. The apparatus of claim 5, wherein the one or more minerals recovered using the NF membrane comprises at least one of: magnesium (Mg²⁺), and calcium (Ca²⁺).

12. The apparatus of claim 5, wherein the apparatus further comprises a reverse osmosis (RO) membrane unit, and wherein the one or more processors are further configured to:
control the RO membrane unit to output a RO brine stream by passing seawater comprising a plurality of chemical compounds through a RO membrane, wherein the seawater passes through the RO membrane to output at least a RO permeate stream and the RO brine stream comprising the first set of minerals.

13. The apparatus of claim 12, wherein the plurality of chemical compounds comprises salts, minerals, and chemical residues.

14. The apparatus of claim 12, wherein the liquid stream is one of: the seawater, or the RO brine stream.

15. A method, comprising:
controlling an inlet to receive a liquid stream comprising a first set of minerals;
controlling a recovery unit to recover one or more minerals from the first set of minerals by passing the liquid stream through a Nanofiltration (NF) membrane having a positive surface charge that repels the one or more minerals for recovery, wherein the liquid stream passes through the NF membrane to output at least: a NF permeate stream and a NF retentate stream comprising the one or more minerals; and
controlling an outlet to output the NF retentate stream comprising the one or more minerals to recover the one or more minerals.

16. The method of claim 15, wherein the NF membrane comprises:
a first layer having a positive surface charge that selectively repels the one or more minerals for the recovery, and
a second layer to provide mechanical support to the first layer.

17. The method of claim 16, wherein the first layer is made of a Metal-Organic Framework (MOF), metal oxide nanoparticles, and a chitosan matrix.

18. The method of claim 16, wherein the second layer is made of a polysulfone ultrafiltration (UF) substrate.

19. The method of claim 15, further comprises:
controlling a reverse osmosis (RO) membrane unit to output a RO brine stream by passing seawater comprising a plurality of chemical compounds through a RO membrane, wherein the seawater passes through the RO membrane to output at least a RO permeate stream and the RO brine stream comprising the first set of minerals.

20. The method of claim 19, wherein the liquid stream is one of: the seawater, or the RO brine stream.
